(19) United States
(12) Patent Application Publication
(10) Pub. No.: US 2014/0196684 A1
(43) Pub. Date: Jul. 17, 2014

(54) SPARK PLUG FOR AN INTERNAL COMBUSTION ENGINE

(71) Applicant: GE Jenbacher GmbH & Co OG, Jenbach (AT)

(72) Inventors: Markus KRAUS, Wiesing (AT); Sean JENKINS, Haimhausen (DE)

(73) Assignee: GE Jenbacher GmbH & Co OG, Jenbach (AT)

(21) Appl. No.: 14/182,749

(22) Filed: Feb. 18, 2014

Related U.S. Application Data
(63) Continuation of application No. PCT/AT2012/000214, filed on Aug. 17, 2012.

(30) Foreign Application Priority Data
Aug. 22, 2011 (AT) 1202/2011

(51) Int. Cl. H01T 13/46; F02B 19/12; H01T 13/32

(52) U.S. Cl. CPC H01T 13/467; H01T 13/32; F02B 19/12
USPC 123/253; 313/140

(57) ABSTRACT

The invention relates to a spark plug for an internal combustion engine, in particular a gas engine. The spark plug includes a middle electrode and at least one earth electrode group, each comprising one or more earth electrode platelets. The middle electrode includes at least one middle electrode platelet having a middle electrode surface, and the middle electrode surface is inclined in a range from 0° to 50°, preferably to at most 45°, to a cross-sectional plane transverse to the longitudinal axis of the spark plug. Each earth electrode platelet of an earth electrode group has an earth electrode surface facing towards the middle electrode surface, spaced apart from the earth electrode surface and running substantially parallel to the earth electrode surface.

The invention concerns a spark plug for an internal combustion engine, in particular a gas engine, comprising a central electrode and at least one ground electrode group respectively including one or more ground electrode platelets, wherein the central electrode has at least one central electrode platelet having a central electrode surface, wherein the central electrode surface is inclined in a range of between 0° and 50°—preferably at a maximum 45°—relative to a cross-sectional plane transversely relative to the longitudinal axis of the spark plug, wherein each ground electrode platelet of a ground electrode group has a ground electrode surface that faces towards the central electrode surface and that is spaced from the central electrode surface and extends substantially parallel to the central electrode surface, wherein a projection of all ground electrode surfaces of the ground electrode platelets of a ground electrode group on to the central electrode surface associated with them in the direction of a normal vector of the central electrode surface gives in total a notional electrode surface wherein the notional electrode surface is of a size of between 8 mm² and 25 mm².

In modern internal combustion engines, in particular in the case of spark-ignition Otto-cycle gas engines, high pressures and temperatures obtain in a combustion chamber, whereby the service lives of the spark plugs used are severely limited. Particularly in the case of highly charged internal combustion engines which are often operated at effective mean pressures >15 bars it can happen with a poor design that a spark plug is in use in the internal combustion engine for only a few hours until the ignition voltage becomes too high because the electrode burns away quickly and operation has to be stopped for adjustment or to replace the spark plug.

To keep the service times and costs of the spark plugs for internal combustion engines at a level which is accepted by customers, the aim is to increase the service life of the spark plug for example by enlarged electrode surfaces. In that case the electrode surfaces represent a reservoir for the electrode consumption. Thus U.S. Pat. No. 5,493,171 discloses a spark plug with enlarged and substantially radial electrode surfaces, wherein the electrodes at least partially comprise titanium diboride to prolong the spark plug service lives. U.S. Pat. No. 5,767,613 also discloses a spark plug having enlarged radial electrode surfaces which are intended to permit more efficient and more complete combustion of a fuel-air mixture. Spark plugs are also known, the electrode surfaces of which are inclined relative to the longitudinal axis of the spark plug (for example U.S. Pat. No. 2,180,528 and DE 24 46 929 A1).

The object in principle of a spark plug is to ignite a fuel-air mixture which is fed to the electrodes. For that purpose on the one hand the ignition system must provide sufficient energy to permit sparking between the electrodes. On the other hand the flame core must have sufficient energy so that it is not cooled down at the electrodes to such an extent that extinction thereof occurs. Therefore the ignition conditions in the case of large electrode surfaces are markedly more difficult than with smaller electrode surfaces.

The object of the invention is to provide a spark plug of the kind set forth in the opening part of this specification, which is improved over the state of the art.

According to the invention that object is attained in that each ground electrode surface of the ground electrode platelets of a ground electrode group is arranged spaced in a range of between 0.2 mm and 0.8 mm from the at least one central electrode surface.

The maximum high-voltage resistance of a usual spark plug main body is at between about 40 kV and 45 kV. Due to the small spacing according to the invention of the ground electrode surfaces of the ground electrode platelets of a ground electrode group from the central electrode surface associated with the ground electrode surfaces it is possible for an internal combustion engine to be already operated at full load with relatively low ignition voltages of for example between 8 kV and 20 kV. The service life of the spark plug until reaching the maximum high-voltage resistance of the spark plug main body by virtue of the electrode consumption and ignition voltages which are increased as a result can thus be prolonged.

In a preferred embodiment it can be provided that each ground electrode surface of the ground electrode platelets of a ground electrode group is arranged spaced by less than or equal to 0.4 mm from the at least one central electrode surface.

By virtue of the arrangement of a central electrode surface and the ground electrode surfaces of the ground electrode platelets of the ground electrode group, that are associated with said central electrode surface and extend substantially parallel with the central electrode surface, at an angle of a maximum of 50° relative to a cross-sectional plane transversely relative to the longitudinal axis of the spark plug, it is also possible to achieve good cooling of the electrodes, by virtue of the short structural lengths, that are possible thereby, of a ground electrode carrier on which the respective ground electrode platelets are arranged and related thereto short distances from a ground electrode platelet to a spark plug main body. That is important in particular in relation to uses in internal combustion engines with a pre-chamber.

In general a ground electrode group can include precisely one ground electrode platelet. It can however also be provided that a ground electrode group includes more than one, preferably two, ground electrode platelets.

In a preferred embodiment it is provided that the central electrode has a plurality of central electrode platelets having a respective central electrode surface and the spark plug includes a plurality of ground electrode groups, wherein the respective ground electrode surfaces of the ground electrode platelets of a ground electrode group of the plurality of ground electrode groups are arranged spaced and substantially parallel to a central electrode surface of the plurality of central electrode surfaces.

In particular it can be provided in that respect that the central electrode has a first central electrode platelet having a first central electrode surface and a second central electrode platelet having a second central electrode surface and the spark plug has a first ground electrode group and a second ground electrode group, wherein the ground electrode surfaces of the ground electrode platelets of the first ground electrode group are arranged spaced and substantially parallel to the first central electrode surface and wherein the ground electrode surfaces of the ground electrode platelets of the second ground electrode group are arranged spaced and substantially parallel to the second central electrode surface.

In an advantageous variant the spark plug has a male thread of a diameter of substantially 18 mm. The male thread can be for example a metric isothread M18. Such a spark plug size is typical of stationary gas engines.

Protection is also claimed for an internal combustion engine, in particular a stationary gas engine, comprising at least one pre-chamber and at least one main combustion chamber and at least one spark plug as set forth in one of claims 1 through 7, wherein the at least one spark plug is arranged in the at least one pre-chamber.

Further details and advantages of the present invention will be described by means of the specific description. In the drawing:

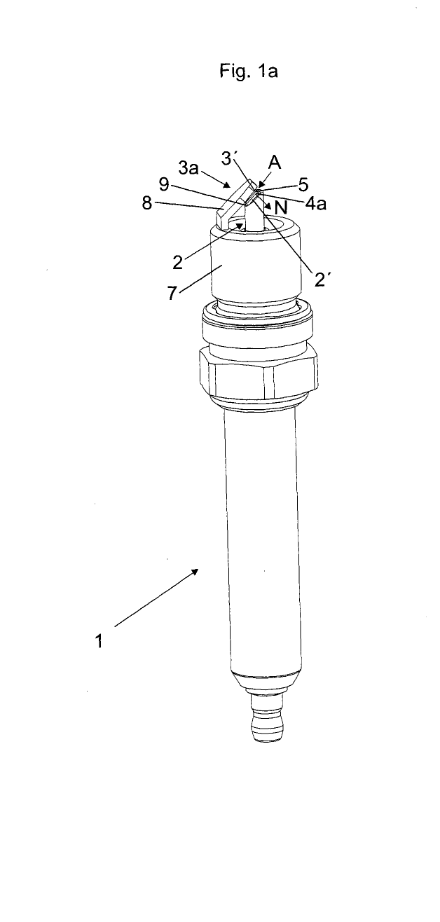

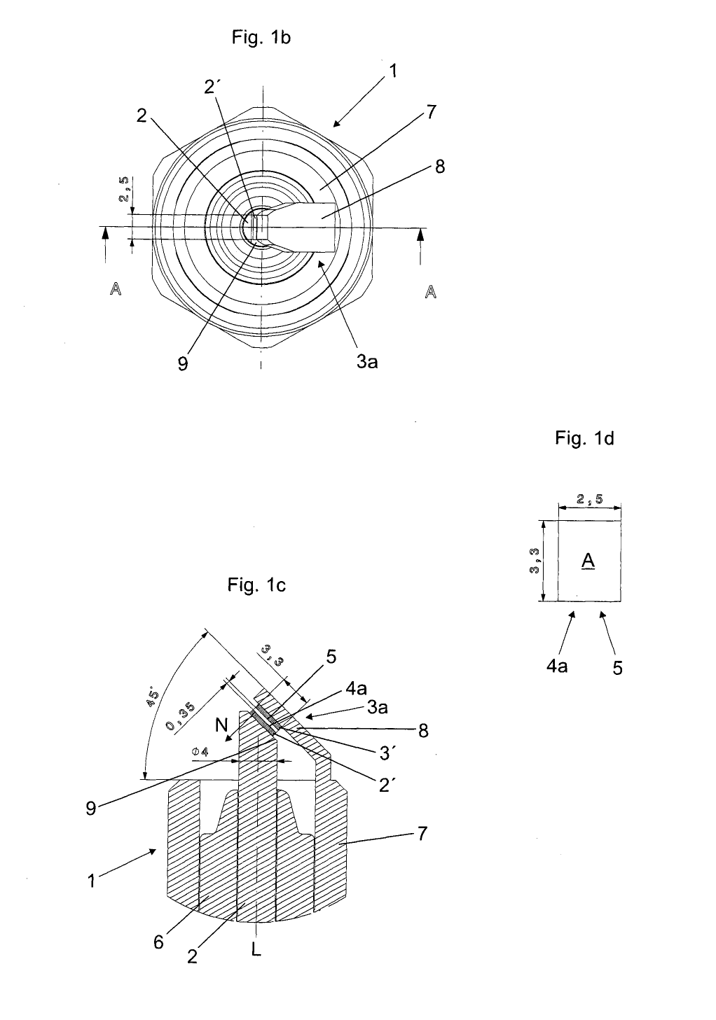

FIG. 1a shows a perspective view of an embodiment of the proposed spark plug,

FIG. 1b shows a plan view of the spark plug of FIG. 1a,

FIG. 1c shows a sectional view along section line AA in FIG. 1b,

FIG. 1d shows a view of the electrode surface of the spark plug of FIG. 1a,

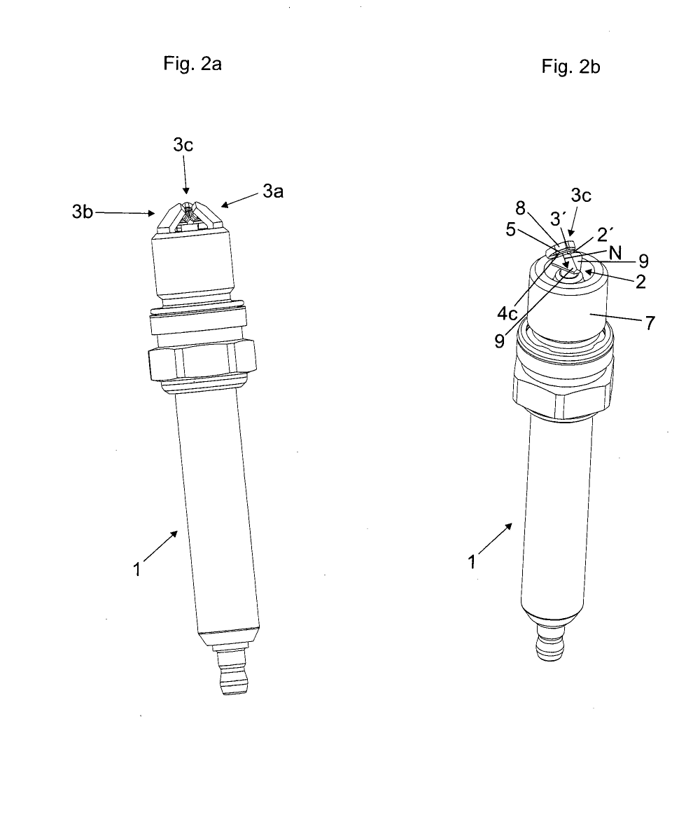

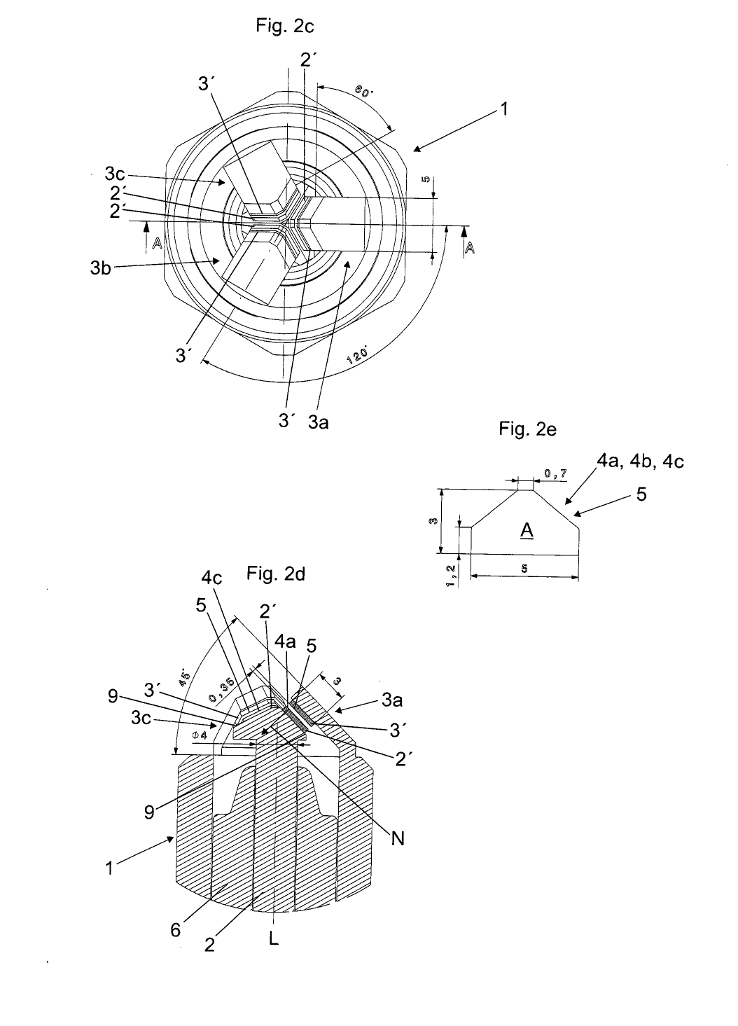

FIGS. 2a and 2b shows perspective views of a further variant of the proposed spark plug,

FIG. 2c shows a plan view of the spark plug of FIG. 2a,

FIG. 2d shows a sectional view along section line AA in FIG. 2c,

FIG. 2e shows a view of an electrode surface of the spark plug of FIG. 2a,

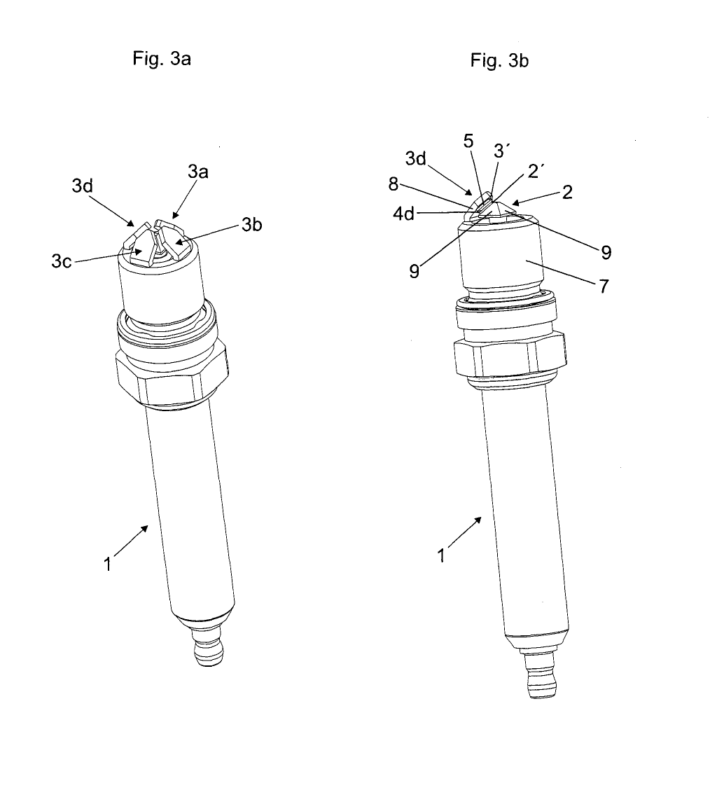

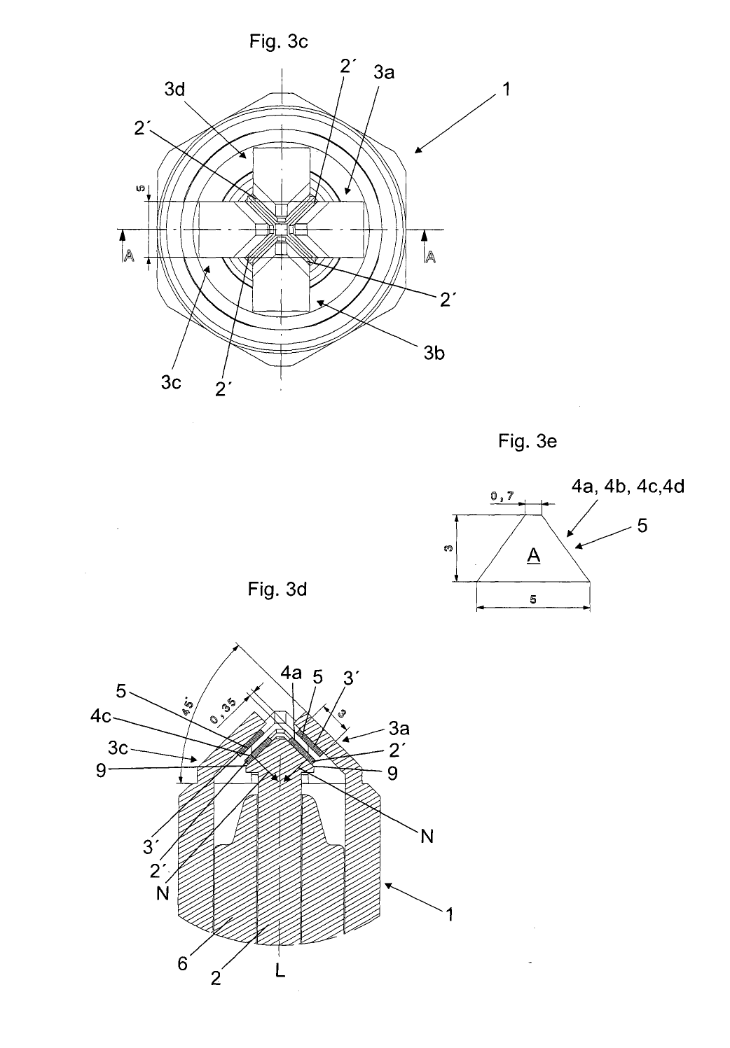

FIGS. 3a and 3b shows perspective views of a further embodiment of the proposed spark plug,

FIG. 3c shows a plan view of the spark plug of FIG. 3a,

FIG. 3d shows a sectional view along section line AA in FIG. 3c,

FIG. 3e shows a view of an electrode surface of the spark plug of FIG. 3a,

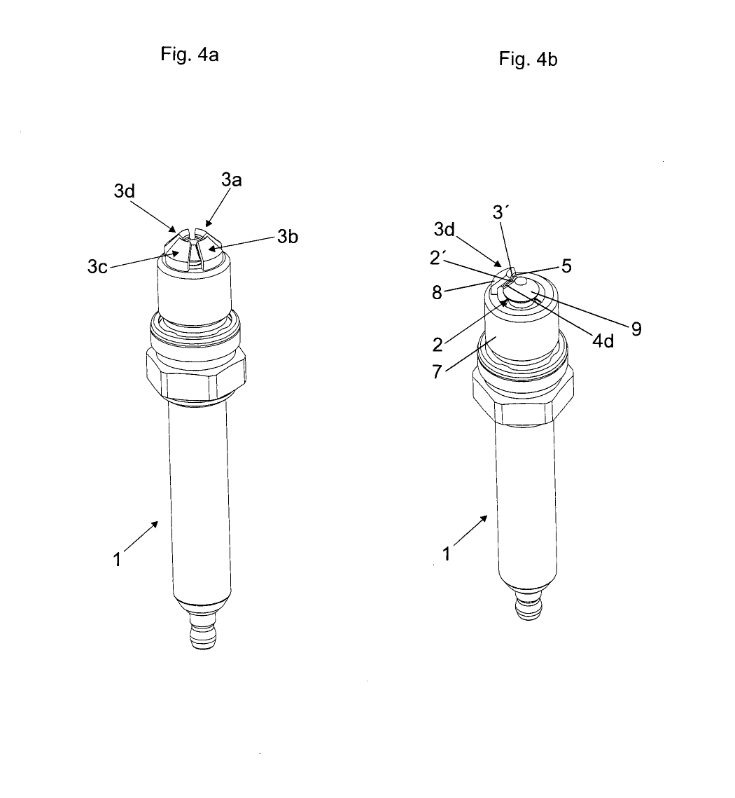

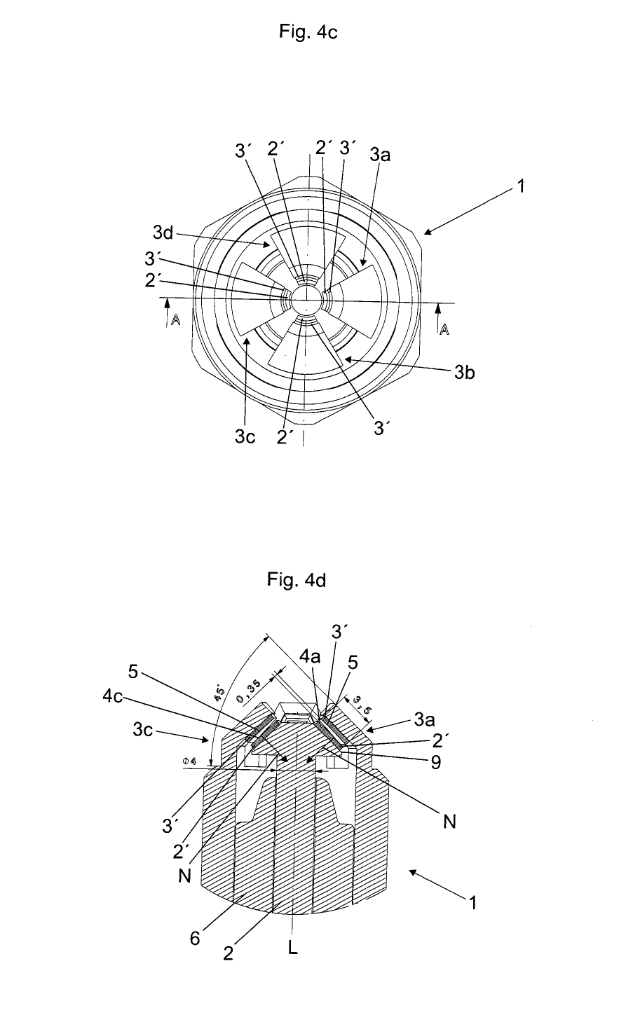

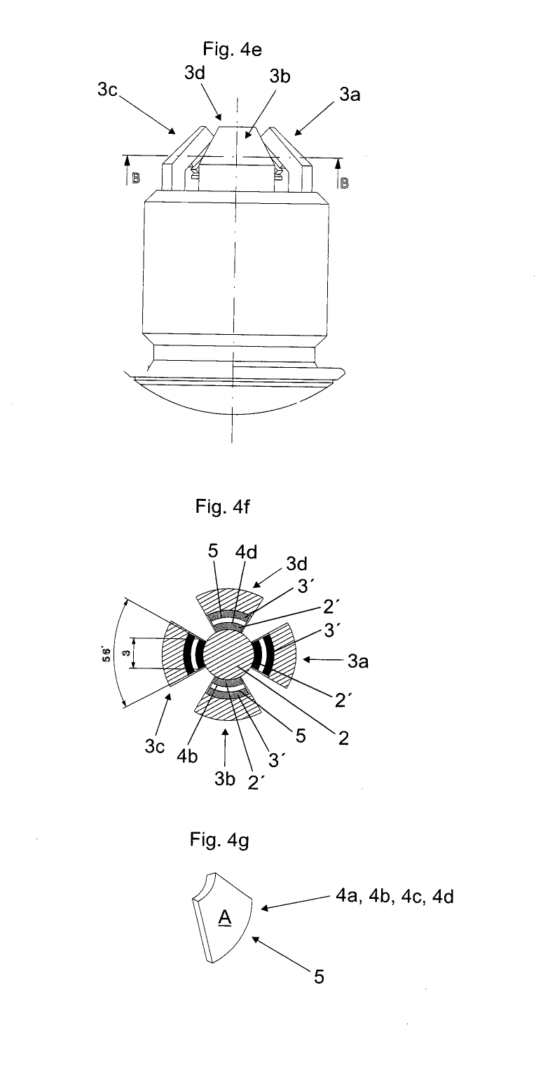

FIGS. 4a and 4b show perspective views of a further embodiment of the proposed spark plug,

FIG. 4c shows a plan view of the spark plug of FIG. 4a,

FIG. 4d shows a sectional view along section line AA in FIG. 4c,

FIG. 4e shows a side view of an end region of the spark plug of FIG. 4a,

FIG. 4f shows a sectional view along section line BB in FIG. 4e,

FIG. 4g shows a perspective view of a central electrode platelet of the spark plug of FIG. 4a,

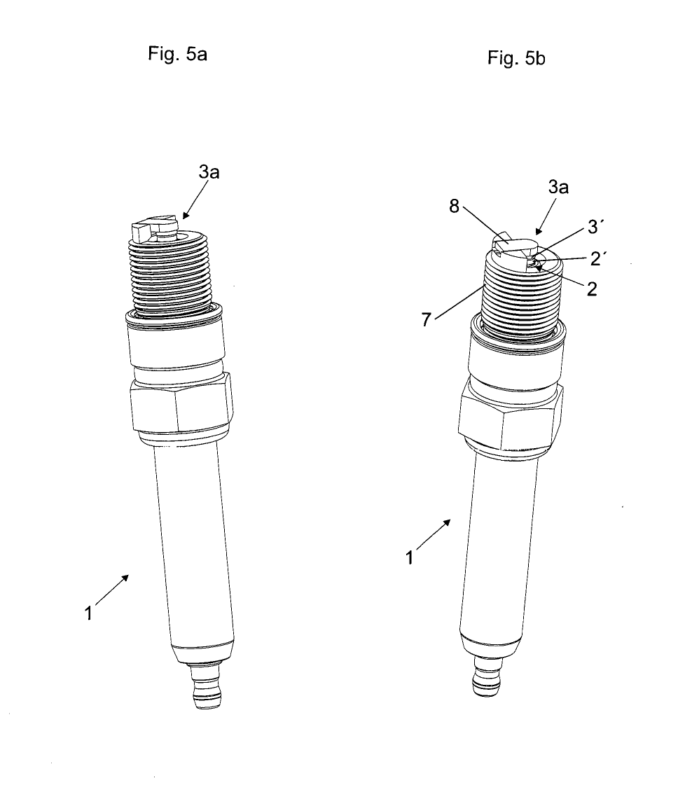

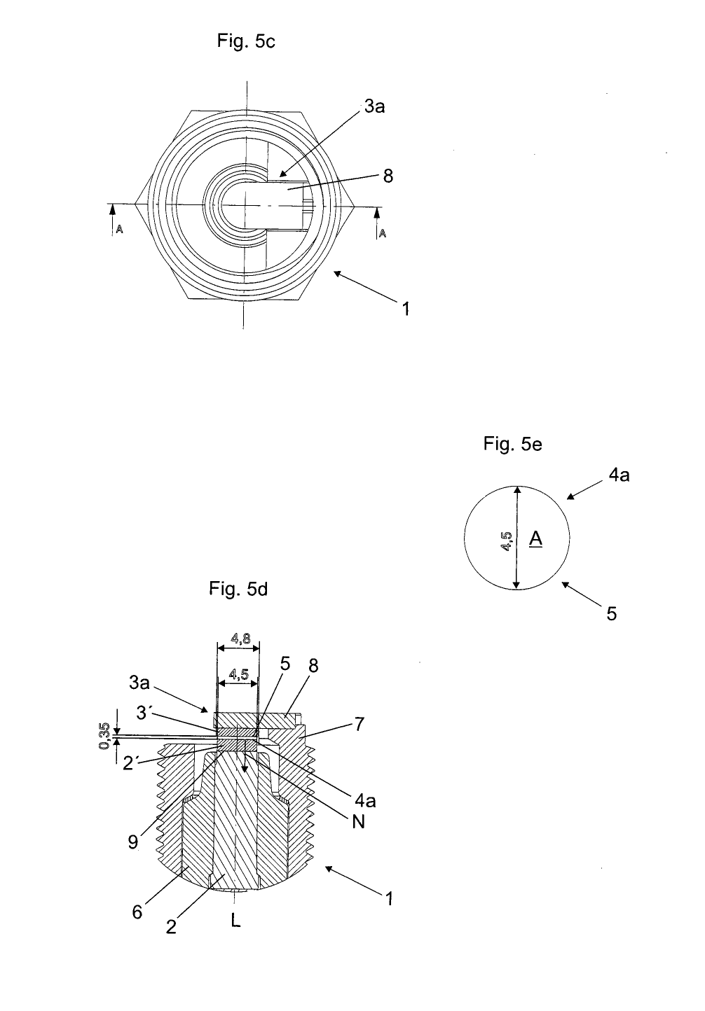

FIGS. 5a and 5b show perspective views of a further embodiment of the proposed spark plug,

FIG. 5c shows a plan view of the spark plug of FIG. 5a,

FIG. 5d shows a sectional view along section line AA in FIG. 5c,

FIG. 5e shows a view of an electrode surface of the spark plug of FIG. 5a,

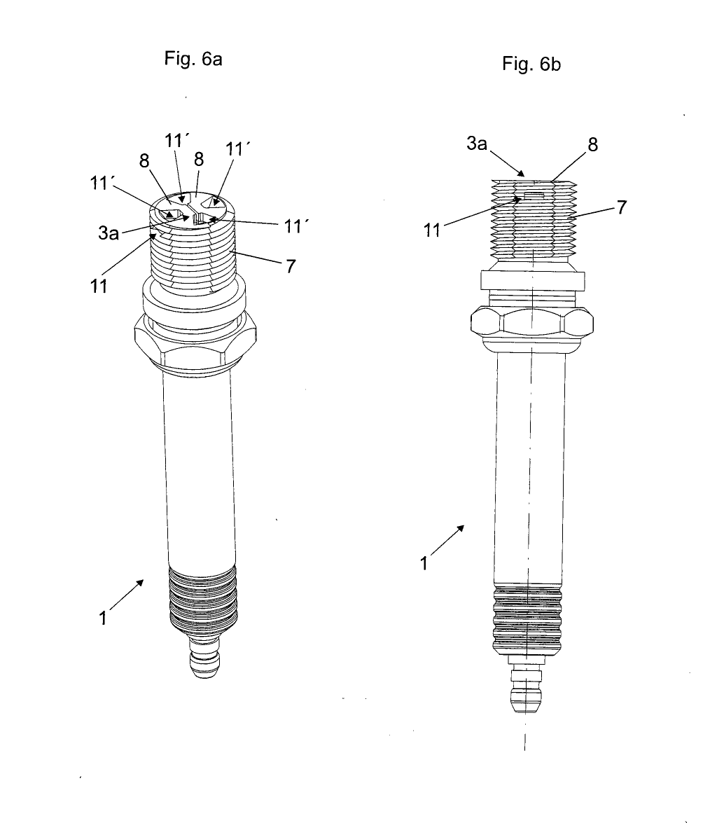

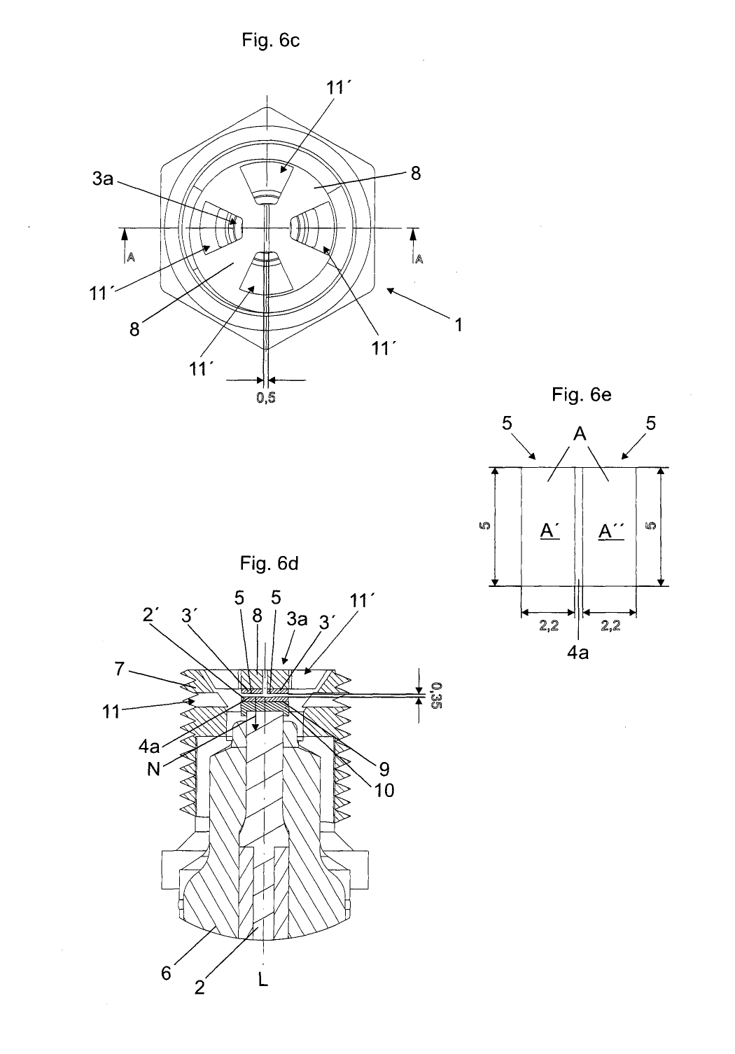

FIG. 6a shows a perspective view of a further embodiment of the proposed spark plug,

FIG. 6b shows a side view of the spark plug of FIG. 6a,

FIG. 6c shows a plan view of the spark plug of FIG. 6a,

FIG. 6d shows a sectional view along section line AA in FIG. 6c,

FIG. 6e shows a view of an electrode surface of the spark plug of FIG. 6a,

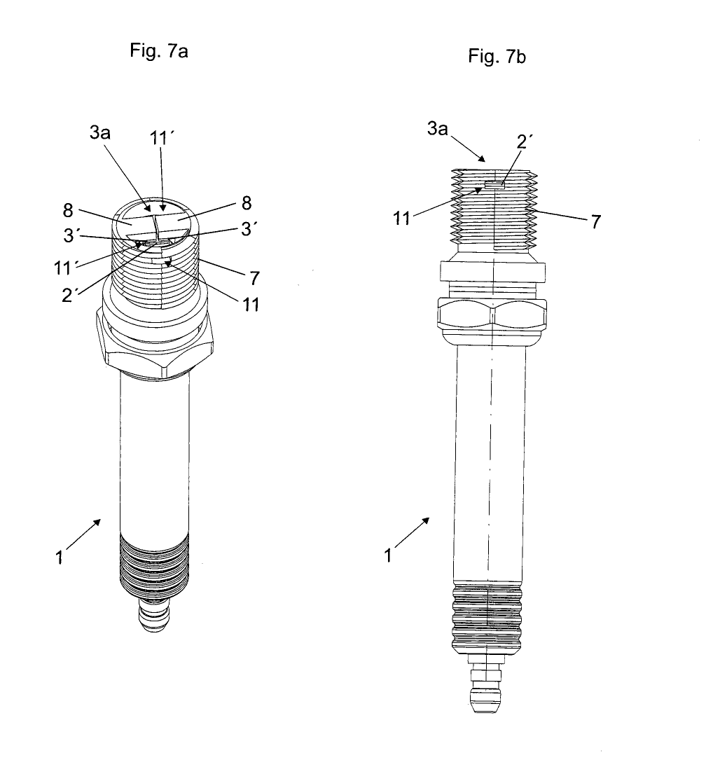

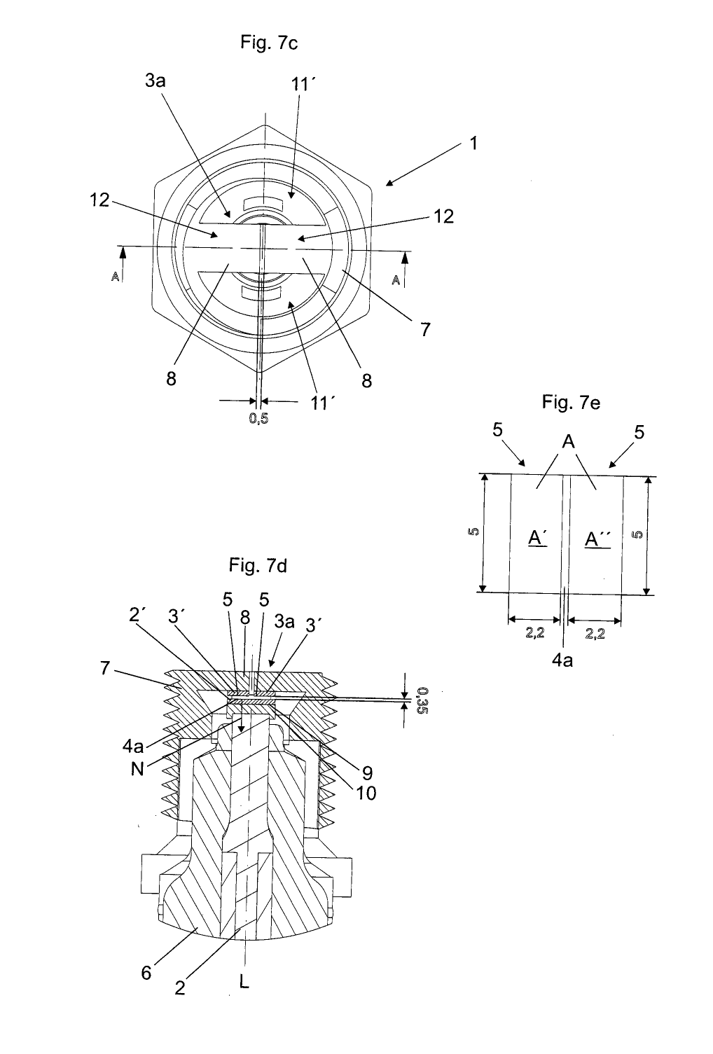

FIG. 7a shows a perspective view of a further embodiment of the proposed spark plug,

FIG. 7b shows a side view of the spark plug of FIG. 7a,

FIG. 7c shows a plan view of the spark plug of FIG. 7a,

FIG. 7d shows a sectional view along section line AA in FIG. 7c, and

FIG. 7e shows a view of an electrode surface of the spark plug of FIG. 7a.

The Figures described hereinafter include some dimensions which are each specified in the unit millimeter (mm).

FIG. 1a shows a perspective view of an embodiment of a proposed spark plug 1. The spark plug 1 has a cylindrical central electrode 2, the end region of the central electrode 2 having an inclined end surface 9. A central electrode platelet 2′ is arranged on that inclined end surface 9. That central electrode platelet 2′ can typically comprise a noble metal or a noble metal alloy and can be joined to the central electrode 2 in known manner, for example by resistance welding.

In addition the spark plug 1 has a usually metallic end region 7 which typically has a male thread whereby the spark plug 1 can be screwed into the cylinder head of an internal combustion engine. The male thread arranged on the metallic end region 7 can be for example a metric isothread M18 of a diameter of substantially 18 mm. Such a spark plug size is a typical size for stationary gas engines.

Arranged at the end of the metallic end region 7 is a ground electrode carrier 8 on which is arranged a ground electrode group 3a including a ground electrode platelet 3′. In this arrangement the central electrode platelet 2′ and the ground electrode platelet 3′ of the ground electrode group 3a are arranged facing each other. The central electrode platelet 2′ has a central electrode surface 4a in the direction of the ground electrode platelet 3′ and the ground electrode platelet 3′ has a ground electrode surface 5 in the direction of the central electrode platelet 2′. The central electrode surface 4a and the ground electrode surface 5 are arranged spaced from each other and extend substantially parallel to each other. In this example the ground electrode surface 5 of the ground electrode platelet 3′ of the ground electrode group 3a is arranged spaced at 0.35 mm from the central electrode surface 4a (see FIG. 1c). The projection of the ground electrode surface 5 of the ground electrode platelet 3′ in the direction of a normal vector N of the central electrode surface 4a gives a notional electrode surface A which is of a size of 8.25 mm² (see FIG. 1d).

FIG. 1b shows a plan view of the spark plug 1 in FIG. 1a. The spark plug 1 has a ground electrode group 3a in the form a single ground electrode carrier 8, on which is arranged a single ground electrode platelet 3′ (in this view concealed by the ground electrode carrier 8). It is also possible to see the central electrode 2, on the end surface 9 of which is disposed a central electrode platelet 2′.

FIG. 1c shows a longitudinal section through an end region of the spark plug 1 along section line AA in FIG. 1b. The central electrode 2 is surrounded by a usually ceramic insulator 6. At its end region the central electrode 2 has an inclined end surface 9 inclined at an angle of 45° relative to a cross-sectional plane transversely to the longitudinal axis L of the spark plug 1. A central electrode platelet 2′ is mounted on that inclined end surface 9. The central electrode platelet 2′ has a central electrode surface 4a which is also inclined at an angle of 45° to a cross-sectional plane transversely to the longitudinal axis L of the spark plug 1, corresponding to the inclined end surface 9.

Arranged at the metallic end region 7 of the spark plug 1 is a ground electrode group 3a in the form of a ground electrode carrier 8, on which a ground electrode platelet 3′ is mounted. In the direction of a normal vector N of the central electrode surface 4a, ground electrode platelets 3′ and central electrode platelets 2′ are arranged in substantially mutually coincident relationship and have equal-sized electrode surfaces (ground electrode surface 5 and central electrode surface 4a). The central electrode surface 4a and the ground electrode surface 5 are arranged mutually spaced at 0.35 mm and extend in substantially mutually parallel relationship.

The projection of the ground electrode surface 5 of the ground electrode platelet 3′ on to the central electrode surface 4a in the direction of a normal vector N of the central electrode surface 4a gives a notional electrode surface A as shown in FIG. 1d. Corresponding to the dimensions given in millimeters (mm), this gives a notional electrode surface area A of 8.25 mm².

FIG. 2a shows a perspective view of a further embodiment of the proposed spark plug 1 and FIG. 2b shows another perspective view, the ground electrode groups 3a and 3b and well as two central electrode platelets 2′ having been removed from the drawing for the sake of clarity. The central electrode 2 of that spark plug 1 has a substantially tetrahedral end region with three end surfaces 9 arranged in a tetrahedral configuration relative to each other. Each of the three end surfaces 9 is inclined through 45° relative to a cross-sectional plane transversely to the longitudinal axis L of the spark plug 1 and a respective central electrode platelet 2′ is arranged at each of the end surfaces 9. Each ground electrode group 3a, 3b, 3c is formed by a respective ground electrode carrier 8 on which a respective ground electrode platelet 3′ is disposed.

FIG. 2c shows a plan view of the spark plug 1 in FIG. 2a and FIG. 2d shows a longitudinal section through an end region of the spark plug 1 along section line AA in FIG. 2c. In this example also the respective central electrode platelet 2′ and the ground electrode platelet 3′ associated therewith of a respective ground electrode group 3a, 3b, 3c are arranged relative to each other in such a way that, in a viewing direction along a normal vector N of the respective central electrode surface 4a, 4b, 4c the respective central electrode surface 4a, 4b, 4c and the ground electrode surface 5 of the ground electrode platelet 3′ of their respectively associated ground electrode group 3a, 3b, 3c are substantially coincident and are of the same contour. Thus for example the ground electrode surface 5 of the ground electrode platelet 3′ of the ground electrode group 3a, in a viewing direction along the normal vector N of the central electrode surface 4a, is substantially coincident with the central electrode surface 4a, that is to say it is of substantially the same contour and also the same surface area. The central electrode surface 4a of the central electrode platelet 2′ and the ground electrode surface 5 of the ground electrode platelet 3′ of the ground electrode group 3a are in this case facing towards each other and arranged spaced from each by 0.35 mm and extend in substantially mutually parallel relationship.

The same arrangement and orientation of central electrode platelet 2′ and ground electrode platelet 3′ relative to each other also applies to the ground electrode platelet 3′ of the ground electrode group 3b and the central electrode platelet 2′ associated therewith, with the central electrode surface 4b, and to the ground electrode platelet 3′ of the ground electrode group 3c and the central electrode platelet 2′, associated therewith, with the central electrode surface 4c.

FIG. 2e shows a view of the notional electrode surface A which is afforded for example by projection of the ground electrode surface 5 of the ground electrode platelet 3′ of the ground electrode group 3a on to the central electrode surface 4a in the direction of a normal vector N of the central electrode surface 4a. By virtue of the dimensions specified in millimeters, for all three projections of a respective ground electrode surface 5 in relation to the respective central electrode surface 4a, 4b, 4c, that respectively gives a notional electrode surface area A of 11.13 mm².

FIG. 3a shows a perspective view of a further embodiment of the proposed spark plug 1 and FIG. 3b shows another perspective view, wherein for the sake of clarity the ground electrode groups 3a, 3b, 3c and three central electrode platelets 2′ have been removed from the view here. FIG. 3c shows a plan view of the spark plug 1 of FIG. 3a and FIG. 3d shows a longitudinal section through an end region of the spark plug 1 along section line AA in FIG. 3c.

The central electrode 2 of this spark plug 1 has a substantially pyramidal end region with four end surfaces 9 arranged in pyramid shape relative to each other. Each of the four end surfaces 9 is inclined through 45° to a cross-sectional plane transversely to the longitudinal axis L of the spark plug 1 and a respective central electrode platelet 2′ is arranged at each of the end surfaces 9. Each ground electrode group 3a, 3b, 3c, 3d is formed by a respective ground electrode carrier 8, on which a respective ground electrode platelet 3′ is arranged. Two respective mutually associated central electrode platelets 2′ and ground electrode platelets 3′ accordingly each have one of the central electrode surfaces 4a, 4b, 4c, 4d and a respective ground electrode surface 5. The respective ground electrode surface 5 is arranged substantially parallel to the central electrode surface 4a, 4b, 4c, 4d associated with it and spaced therefrom by 0.35 mm in each case.

Overall this spark plug 1 involves four notional electrode surfaces A as shown in FIG. 3e, for example by projection of the ground electrode surface 5 of the ground electrode platelet 3′ of the ground electrode group 3a on to the central electrode surface 4a in the direction of a normal vector N of the central electrode surface 4a. By virtue of the dimensions specified in millimeters that involves a notional electrode surface area A of 8.55 mm² in each case.

FIG. 4a shows a perspective view of a further embodiment of the proposed spark plug 1 and FIG. 4b shows another perspective view, the ground electrode groups 3a, 3b, 3c and three central electrode platelets 2′ having been removed from the view here for the sake of clarity. FIG. 4c shows a plan view of the spark plug of FIG. 4a and FIG. 4d shows a longitudinal section through an end region of the spark plug 1 along section line AA in FIG. 4c. FIG. 4e shows a side view of an end region of the spark plug 1 of FIG. 4a and FIG. 4f shows a cross-section through the end region of the spark plug 1 along section line BB in FIG. 4e. FIG. 4g shows a perspective view of a central electrode platelet 2′ of the spark plug 1 of FIG. 4a.

The central electrode 2 of this spark plug 1 has a substantially frustoconical end region with a peripherally extending circumferential surface which forms an end surface 9 of the central electrode 2. The angle between a peripheral line of the end surface 9 and a cross-sectional plane transversely to the longitudinal axis L of the spark plug 1 is 45° (see FIG. 4d). Each of the four ground electrode groups 3a, 3b, 3c, 3d of this spark plug has associated therewith a respective central electrode platelet 2′ which is shaped corresponding to the frustoconical configuration of the end surface 9 and which is mounted to the end surface 9. Each ground electrode group 3a, 3b, 3c, 3d is formed by a respective ground electrode carrier 8 on which a respective ground electrode platelet 3′ is arranged.

The ground electrode platelets 3′ are also shaped to correspond to the frustoconical configuration of the end surface 9, so that a respective ground electrode surface 5 of the ground electrode platelet 3′ of a ground electrode group 3a, 3b, 3c, 3d and the central electrode surface 4a, 4b, 4c, 4d associated with it extend in spaced and substantially mutually parallel relationship, wherein the electrode surfaces in this case are non-flat surfaces. As can be seen from FIGS. 4f and 4d the respectively mutually facing and curved surfaces of mutually associated central electrode platelets 2′ and ground electrode platelets 3′ are arranged spaced from each other by 0.35 mm. Each of the four notional electrode surfaces A is substantially a sector portion of a peripheral surface of a truncated cone, that extends around the central electrode surfaces 4a, 4b, 4c, 4d, and it is of a size of between 8 mm² and 25 mm².

FIGS. 5a and 5b show two perspective views of a further embodiment of the proposed spark plug 1. FIG. 5c shows a plan view of the spark plug 1 in FIG. 5a and FIG. 5d shows a longitudinal section through an end region of the spark plug 1 along section line AA in FIG. 5c. FIG. 5e shows a view of the notional electrode surface A afforded by projection of the ground electrode surface 5 of the ground electrode platelet 3′ of the ground electrode group 3a on to the central electrode surface 4a in the direction of a normal vector N of the central electrode surface 4a.

The metallic end region 7 of this spark plug 1 has a male thread in the form of a metric isothread M18 of a diameter of substantially 18 mm. Arranged at the end of the metallic end region 7 is a ground electrode carrier 8 on which a ground electrode group 3a including a ground electrode platelet 3′ is arranged.

The cylindrical central electrode 2 has an end surface 9 arranged substantially transversely to the longitudinal axis L of the spark plug 1. Arranged on that end surface 9 is a central electrode platelet 2′, wherein the central electrode platelet 2′ has a substantially circular central electrode surface 4a arranged substantially transversely to the longitudinal axis L of the spark plug 1. In other words the angle between the central electrode surface 4a and a cross-sectional plane transversely to the longitudinal axis L of the spark plug 1 is substantially 0°.

The central electrode platelet 2′ and the ground electrode platelet 3′ of the ground electrode group 3a are arranged in mutually facing relationship. The central electrode platelet 2′ has the central electrode surface 4a in the direction of the ground electrode platelet 3′ and the ground electrode platelet 3′ has a ground electrode surface 5 in the direction of the central electrode platelet 2′. The central electrode surface 4a and the ground electrode surface 5 are arranged spaced from each other and extend in substantially mutually parallel relationship. The ground electrode surface 5 of the ground electrode platelet 3′ of the ground electrode group 3a is arranged spaced in this example at 0.35 mm from the central electrode surface 4a (see FIG. 5d).

The ground electrode surface 5 is substantially circular and is of a diameter of 4.8 mm. The central electrode surface 4a is also substantially circular and being of a diameter of 4.5 mm is somewhat smaller than the ground electrode surface 5. The projection of the ground electrode surface 5 of the ground electrode platelet 3′ on to the central electrode surface 4a in the direction of a normal vector N of the central electrode surface 4a accordingly affords a notional substantially circular electrode surface A of a diameter of 4.5 mm (see FIGS. 5d and 5e). That gives a size for the notional electrode surface A of 15.9 mm².

FIG. 6a shows a perspective view of a further embodiment of the proposed spark plug 1 and FIG. 6b shows a side view of the spark plug 1, FIG. 5c shows a plan view of the spark plug 1 in FIG. 6a and FIG. 6d shows a longitudinal section through an end region of the spark plug 1 along section line AA in FIG. 6c .

This spark plug 1 has two ground electrode carriers 8 which are arranged substantially within the metallic end region 7 of the spark plug 1 and substantially in surface-flush relationship with the end of the metallic end region 7. In this case a respective ground electrode platelet 3′ is arranged on each ground electrode carrier 8.

Each of the two ground electrode carrier 8 is of a substantially U-shaped configuration in plan (see FIG. 6c). This substantially U-shaped configuration of the ground electrode carriers 8 in conjunction with relatively large cross-sections of the ground electrode carriers 8 permits good heat dissipation of that heat which acts on the ground electrode carrier 8 in the direction of the spark plug main body or the metallic end region 7 of the spark plug 1.

Arranged in the end region of the central electrode 2 of this spark plug is a central electrode carrier 10 which in this case has an end surface 9 of the central electrode 2. This end surface 9 is arranged substantially transversely relative to the longitudinal axis L of the spark plug. Disposed on the end surface 9 is a central electrode platelet 2′ whose central electrode surface 4a is also arranged substantially transversely to the longitudinal axis L of the spark plug 1.

The total of two ground electrode platelets 3′ on the two ground electrode carriers 8 are arranged facing the one central electrode platelet 2′, thereby forming a single ground electrode group 3a. Each ground electrode platelet 3′ has a ground electrode surface 5. In this arrangement the two ground electrode surfaces 5 are disposed facing the central electrode surface 4a in the direction of the longitudinal axis L of the spark plug 1. The ground electrode surfaces 5 of the two ground electrode platelets 3′ of the ground electrode group 3a extend substantially parallel to the central electrode surface 4a and are arranged spaced therefrom at 0.35 mm.

For checking and adjusting the spacings between the central electrode platelet 2′ and the ground electrode platelets 3′ or between the central electrode surface 4a and the two ground electrode surfaces 5 associated therewith, openings 11 are provided at the peripheral surface of the metallic end region 7.

For good accessibility of fuel or fuel-air mixture to the electrode platelets (central electrode platelets 2′ and ground electrode platelets 3′) arranged within the metallic end region 7, provided at the end of the metallic end region 7 are a plurality of openings 11′ which are formed by a suitable arrangement and substantially U-shaped configuration of the ground electrode carriers 8.

A notional electrode surface A is always provided for each ground electrode group. It results in each case from the total in terms of surface area of the projections of all ground electrode surfaces of the ground electrode platelets of the ground electrode group in question on to the central electrode surface, associated with them, in the direction of a normal vector of the central electrode surface.

FIG. 6e shows a view of the resulting notional electrode surface A of the ground electrode group 3a of this spark plug 1. The projection of the two ground electrode surfaces 5 of the ground electrode platelets 3′ of the ground electrode group 3a on to the central electrode surface 4a in the direction of a normal vector N of the central electrode surface 4a gives the two projection surface areas A′ and A″. In accordance with the dimensions specified in millimeters of the substantially rectangular ground electrode surfaces 5 each of the two projection surface areas A′ and A″ is of a size of 11 mm².

The projections of both ground electrode surfaces 5 of the two ground electrode platelets 3′ of the ground electrode group 3a on to the central electrode surface 4a in the direction of a normal vector N of the central electrode surface 4a now afford in total the notional electrode surface A of a total size of 22 mm².

FIG. 7a shows a perspective view of a further embodiment of the proposed spark plug 1 and FIG. 7b shows a side view of that spark plug 1. FIG. 7c shows a plan view of the spark plug 1 of FIG. 7a and FIG. 7d shows a longitudinal section through an end region of the spark plug 1 along section line AA in FIG. 7c.

Like the spark plug 1 of FIGS. 6a through 6e the spark plug 1 of this example has two ground electrode carriers 8 which are arranged substantially within the metallic end region 7 of the spark plug 1 and substantially in surface-flush relationship with the end of the metallic end region 7. Once again a respective ground electrode platelet 3′ is arranged at each ground electrode carrier 8. In a plan view each of the two ground electrode carriers 8 has a bar 12 extending in the direction of the spark plug center (see FIG. 6c). At their facing ends the two bars 12 are arranged spaced from each other by 0.5 mm in this example. The two ground electrode carriers 8 in the form of the two bars 12 are in this example formed in one piece with the metallic end region 7 (see FIG. 7d).

Like the spark plug 1 shown in FIGS. 6a through 6e the two ground electrode platelets 3′ arranged on the two ground electrode carriers 8 represent the single ground electrode group 3a of this spark plug 1 as both ground electrode platelets 3′ are arranged opposite the same central electrode platelet 2′ and facing same.

The configuration of the central electrode 2 with the central electrode carrier 10 and central electrode platelets 2′ arranged thereon as well as the arrangement and orientation of the ground electrode surfaces 5 of the ground electrode platelets 3′ of the ground electrode group 3a in relation to the central electrode surface 4a, associated with them, of the single central electrode platelet 2′ substantially corresponds to the spark plug 1 shown in FIG. 6a through 6e.

Corresponding openings 11 for checking and setting the electrode spacing at the peripheral surface and openings 11′ for improved fuel or fuel-air mixture accessibility to the end face of the metallic end region 7 of the spark plug 1 are also provided as in the spark plug 1 of FIGS. 6a through 6d.

The two projection surfaces A′ and A″ formed by the two projections of the ground electrode surfaces 5 of the two ground electrode platelets 3′ of the ground electrode group 3a on to the central electrode surface 4a in the direction of a normal vector N of the central electrode surface 4a provide, as in the spark plug 1 of FIG. 6a through 6e, in total the notional electrode surface A of the ground electrode group 3a involving an overall size of 22 mm² (see FIG. 7e).

1. A spark plug for an internal combustion engine, in particular a gas engine, comprising a central electrode and at least one ground electrode group respectively including one or more ground electrode platelets, wherein the central electrode has at least one central electrode platelet having a central electrode surface, wherein the central electrode surface is inclined in a range of between 0° and 50°—preferably at a maximum 45°—relative to a cross-sectional plane transversely relative to the longitudinal axis of the spark plug, wherein each ground electrode platelet of a ground electrode group has a ground electrode surface that faces towards the central electrode surface and that is spaced from the central electrode surface and extends substantially parallel to the central electrode surface, wherein a projection of all ground electrode surfaces of the ground electrode platelets of a ground electrode group on to the central electrode surface associated with them in the direction of a normal vector of the central electrode surface gives in total a notional electrode surface wherein the notional electrode surface is of a size of between 8 mm² and 25 mm², characterised in that wherein each ground electrode surface of the ground electrode platelets of a ground electrode group is arranged spaced in a range of between 0.2 mm and 0.8 mm from the at least one central electrode surface.

2. A spark plug as set forth in claim 1 wherein each ground electrode surface of the ground electrode platelets of a ground electrode group is arranged spaced by less than or equal to 0.4 mm from the at least one central electrode surface.

3. A spark plug as set forth in claim 1 wherein the at least one ground electrode group includes precisely one ground electrode platelet.

4. A spark plug as set forth in claim 1 wherein the at least one ground electrode group includes more than one, preferably two, ground electrode platelets.

5. A spark plug as set forth in claim 1 wherein the central electrode surface extends substantially parallel to a cross-sectional plane transversely relative to the longitudinal axis of the spark plug.

6. A spark plug as set forth in claim 1 wherein the central electrode has a plurality of central electrode platelets having a respective central electrode surface and the spark plug includes a plurality of ground electrode groups, wherein the respective ground electrode surfaces of the ground electrode platelets of a ground electrode group of the plurality of ground electrode groups are arranged spaced and substantially parallel to a central electrode surface of the plurality of central electrode surfaces.

7. A spark plug as set forth in claim 6 wherein the central electrode has a first central electrode platelet having a first central electrode surface and a second central electrode platelet having a second central electrode surface and the spark plug has a first ground electrode group and a second ground electrode group, wherein the ground electrode surfaces of the ground electrode platelets of the first ground electrode group are arranged spaced and substantially parallel to the first central electrode surface and wherein the ground electrode surfaces of the ground electrode platelets of the second ground electrode group are arranged spaced and substantially parallel to the second central electrode surface.

8. A spark plug as set forth in claim 1 wherein the central electrode has a substantially tetrahedral end region having three end surfaces which are arranged in tetrahedral relationship with each other, wherein arranged at each of the end surfaces is a respective central electrode platelet having a respective central electrode surface, wherein the spark plug includes three ground electrode groups, wherein the ground electrode surfaces of the ground electrode platelets of one of the three ground electrode groups are respectively arranged spaced and substantially parallel to one of the three central electrode surfaces.

9. A spark plug as set forth in claim 8 wherein the end surfaces are inclined through substantially 45° relative to a cross-sectional plane transversely to the longitudinal axis of the spark plug.

10. A spark plug as set forth in claim 1 wherein the central electrode has a substantially pyramidal end region having four end surfaces which are arranged in pyramidal relationship with each other, wherein arranged at each of the end surfaces is a respective central electrode platelet having a respective central electrode surface, wherein the spark plug includes four ground electrode groups, wherein the ground electrode surfaces of the ground electrode platelets of one of the four ground electrode groups are respectively arranged spaced and substantially parallel to one of the four central electrode surfaces.

11. A spark plug as set forth in claim 10 wherein the end surfaces are inclined through substantially 45° relative to a cross-sectional plane transversely to the longitudinal axis of the spark plug.

12. A spark plug as set forth in claim 1 wherein the spark plug has a male thread of a diameter of substantially 18 mm.

13. An internal combustion engine, in particular a stationary gas engine, comprising at least one pre-chamber and at least one main combustion chamber and at least one spark plug as set forth in claim 1, wherein the at least one spark plug is arranged in the at least one pre-chamber.
